(19) United States
(12) Patent Application Publication
(10) Pub. No.: US 2015/0357744 A1
(43) Pub. Date: Dec. 10, 2015

(54) HINGE ARRANGEMENT

(71) Applicant: ROLLS-ROYCE PLC, London (GB)

(72) Inventors: Peter ALLFORD, Bristol (GB); Peter WARBURTON, Dursley (GB)

(21) Appl. No.: 14/712,503

(22) Filed: May 14, 2015

(30) Foreign Application Priority Data
Jun. 10, 2014 (GB) 1410239.6

(51) Int. Cl. H01R 13/50; E05D 3/12; F02C 7/04; E05D 11/00

(52) U.S. Cl. CPC H01R 13/501; E05D 11/0081; E05D 3/12; F02C 7/04

(57) ABSTRACT

There is proposed a hinge arrangement (29) configured to hingedly interconnect a first component (26) and a second component (27). The hinge arrangement (29) incorporates a first part (37) of an electrical connector (38) which is formed as an integral feature of the hinge arrangement (29), said first part (37) of the electrical connector (38) being configured to releasably and electrically engage a second part (40) of the electrical connector (38) such that the second part (40) of the electrical connector is separable from the hinge arrangement (29). In one embodiment the first and second components (26, 27) form part of the nose cone assembly (24) of a gas turbine engine (10)

The present invention relates to a hinge arrangement, and more particularly relates to a hinge arrangement configured to hingedly interconnect a first component and a second component. The invention provides benefits in arrangements in which the first and second components are required to be electrically connected as well as hingedly connected.

In the context of gas turbine engines in the aeronautical industry, and in particularly gas turbine engines of the ducted fan type, it is known to provide the nose cone of the fan and the front region of the engine's nacelle with electrically heated elements to prevent the potentially dangerous build-up of ice during high altitude operation. Typically, the heating elements are provided in the form of flexible mats which are incorporated in the composite structure of the nose cone and nacelle.

Current designs of heated nose cones for gas turbine engines are configured such that at least the front part of the nose cone is removable from the underlying supporting structure at the hub of the engine's propulsive fan, to permit access behind the nose cone for servicing and repair purposes. The heating elements provided in the removable part of the nose cone are connected to an electrical power supply mounted within the main part of the engine by a length of flexible cable which is usually coiled and stowed in the cavity behind the nose cone, and which may be retained in position by a series of retaining clips when the nose cone is installed in its normal configuration. In order to permit access behind the nose cone for servicing, the cable is of sufficient length to permit the nose cone to be removed from the engine and moved clear without requiring disconnection of its heating elements from the power supply. This necessitates quite a long connecting cable which can be difficult to coil and stow behind the nose cone properly when the nose cone is subsequently replaced. As will be appreciated, this problem is often exacerbated by the fact that access to the cavity within the nose cone, and clear vision of the cable therein, is obstructed as the nose cone is replaced. There has therefore been found to be an unacceptable risk of the cable becoming damaged either by snagging, twisting or becoming trapped between the nose cone and its supporting structure, which can lead to damage to the cable and inoperability of the heating elements.

It is an object of the present invention to provide an improved hinge arrangement.

According to a first aspect of the present invention, there is provided a hinge arrangement configured to hingedly interconnect a first component and a second component, the hinge arrangement incorporating a first part of an electrical connector which is formed as an integral feature of the hinge arrangement, said first part of the electrical connector being configured to releasably and electrically engage a second part of the electrical connector such that the second part of the electrical connector is separable from the hinge arrangement.

Preferably, said first part of the electrical connector is provided in the form of a socket formed as an integral feature of the hinge arrangement, and said second part of the electrical connector is provided as a plug configured for releasable and electrical connection to the socket.

Advantageously, said socket is configured to receive said plug along an insertion axis which is substantially aligned with a pivot axis of the hinge arrangement.

Conveniently, said socket is configured to receive said plug along an insertion axis which is substantially coincident with a pivot axis of the hinge arrangement.

Preferably, said first part of the electrical connector is electrically connected to electrical circuitry provided on said first component.

Said first part of the electrical connector may be permanently connected to said circuitry on said first component via a cable.

Advantageously, said circuitry on the first component includes at least one heating element.

Conveniently, said second part of the electrical connector is electrically connected to circuitry which is separate from said first component.

Said second part of the electrical connector may be permanently connected to said circuitry which is separate from the first component via a cable.

At least said cable connecting said second part of the electrical connector to said circuitry separate from the first component is a ribbon cable.

Preferably, said electrical circuitry separate from the first component includes a power supply.

The hinge arrangement may optionally have at least two pivot axes.

Conveniently, said pivot axes are substantially parallel.

In one embodiment, said first and second components both form part of a nose cone assembly for a gas turbine engine.

According to a second aspect of the present invention, there is provided a gas turbine engine incorporating a hinge arrangement according to the first aspect.

So that the invention may be more readily understood, and so that further features thereof may be appreciated, embodiments of the invention will now be described by way of example with reference to the accompanying drawings in which:

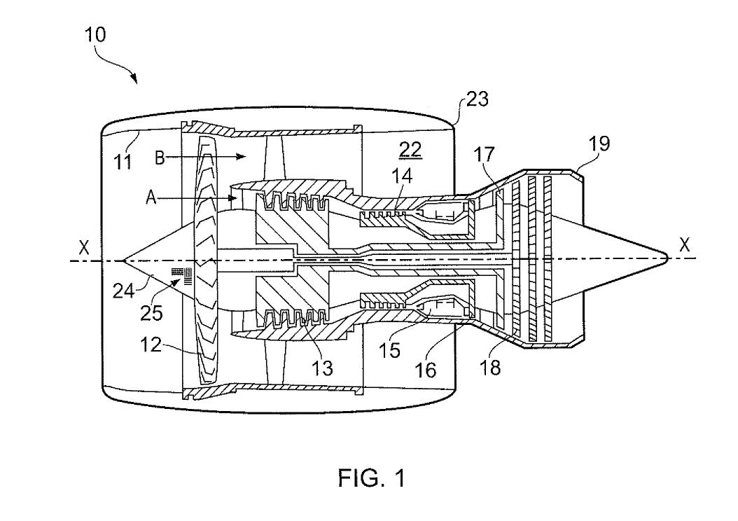

FIG. 1 is a schematic longitudinal cross-sectional view through a ducted fan gas turbine engine;

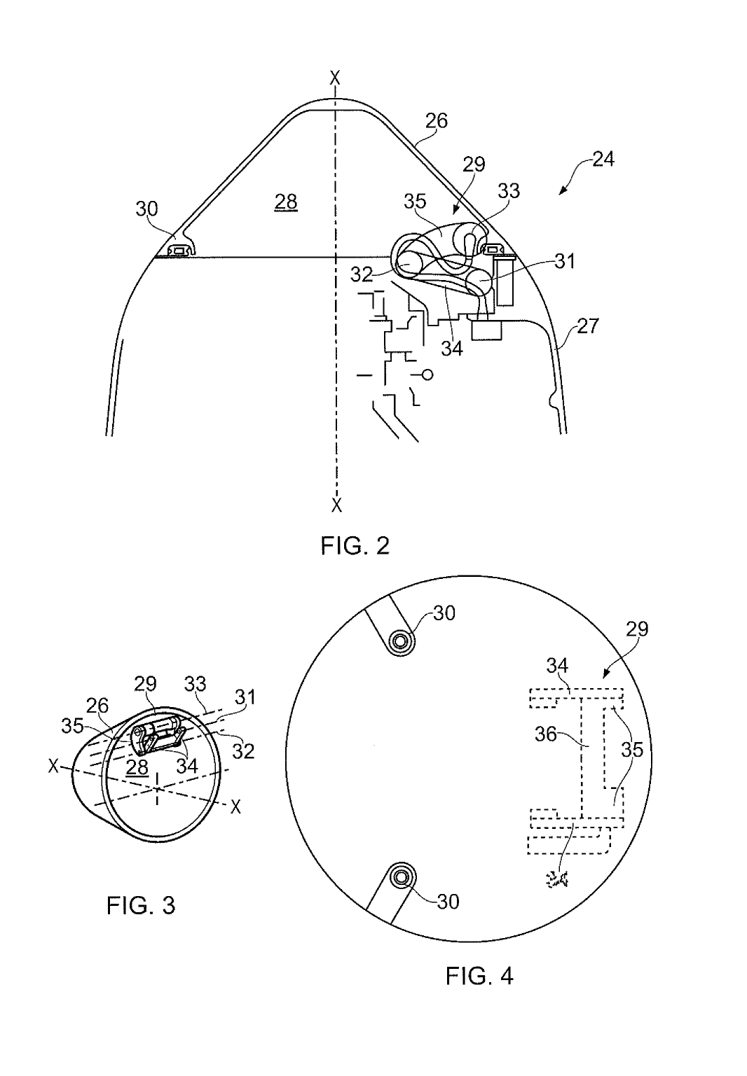

FIG. 2 is a schematic part-sectional view through the nose cone of the propulsive fan of the engine illustrated in FIG. 1, showing the nose cone in a normal, closed, position;

FIG. 3 is a schematic perspective view, from behind, showing a hinge mechanism of the nose cone;

FIG. 4 is a schematic view from the front of the nose cone shown in FIGS. 2 and 3;

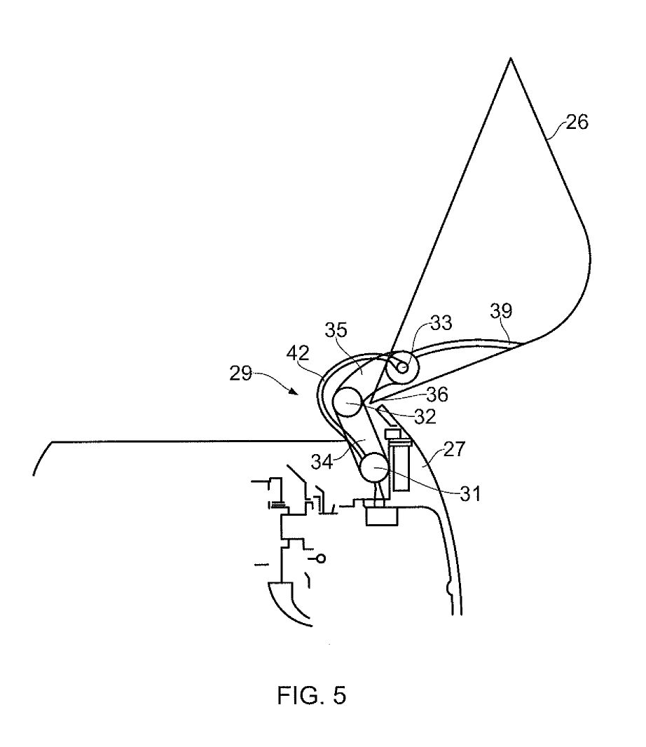

FIG. 5 is a schematic perspective view similar to that of FIG. 2, but which shows the nose cone in an alternate, open, position; and

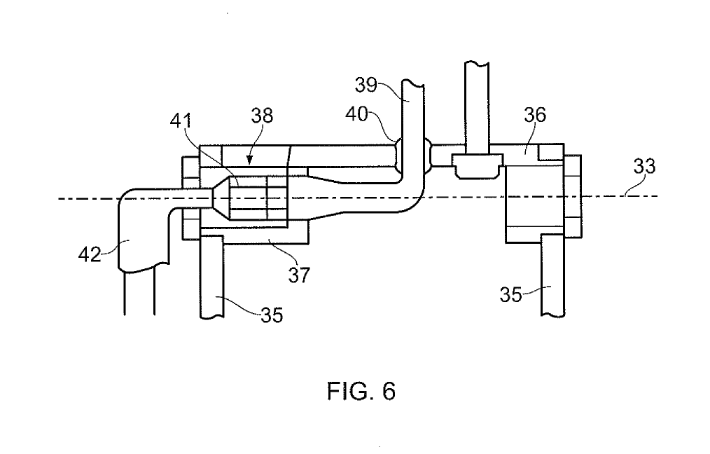

FIG. 6 is a more detailed drawing showing the hinge mechanism of the nose cone.

With reference to FIG. 1, a ducted fan gas turbine engine incorporating the invention is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

As is conventional, the propulsive fan 12 has a central and generally forwardly extending nose cone 24 which is conical about the rotational axis X-X of the engine. The nose cone 24 incorporates a series of electric heating elements (illustrated schematically at 25) in order to prevent the build-up of ice on the outer surface of the nose cone 24 during high altitude operation of the engine 10. The heating elements 25 are typically provided as pre-formed mats which are set into the composite material of the nose cone. As will be appreciated, the heating elements 25 require a supply of electric power, and this is provided from a power supply (not shown) mounted at a convenient position within the main part of the engine and thus separate from the nose cone 24. The heating elements 25 are therefore required to be electrically connected to the power supply.

Turning now to consider FIGS. 2 to 4 in more detail, the nose cone 24 of the engine 10 comprises two main components, namely first component in the form of a spinner 26, and a second component in the form of a supporting structure 27 at the centre of the fan 12 to which the spinner 26 is mounted. The spinner 26 is provided in the form of a hollow housing which may be generally conical in form and which defines an internal cavity 28 to the nose cone. The spinner 26 is hingedly mounted to the supporting structure 27 via a hinge arrangement 29 so that it may be moved between a closed position as illustrated in FIG. 2, to an open position as illustrated in FIG. 5. As will be appreciated, during operation of the engine 10 the nose cone is locked in its close position as illustrated in FIG. 1 so as to define a smooth profile immediately in front of the fan 12 to ensure smooth airflow into the radially innermost regions between the fan's blades. As illustrated schematically in FIGS. 2 and 4, the spinner 26 may be secured in its closed position for operation by a pair of spaced-apart bolts 30 or similar fixtures, the bolts 30 passing through respective apertures formed in the spinner and engaging the support structure 27 behind the spinner.

In the embodiment illustrated, the hinge arrangement 29 is configured such that it has three distinct and parallel pivot axes 31, 32, 33. In more detail, the hinge arrangement comprises a first pair of hinge arms 34 which are both pivotally mounted to the support structure at one end about the first pivot axis 31 for pivotal movement relative to the support structure 27. At their opposite ends, the first hinge arms 34 are each pivotally connected to the ends of respective second hinge arms 35 about the second pivot axis 32, the second hinge arms 35 also being spaced apart from one another. The opposite ends of the second hinge arms 35 are pivotally connected to the spinner 26 about the third pivot axis 33, at a position located just inside the cavity 28 of the spinner. In the arrangement illustrated, the first hinge arms 34 are straight, and the second hinge arms 35 are slightly arcuate.

The above-described hinge arrangement 29, comprising two pairs of hinge arms 34, 35 and three pivot axes 31, 32, 33, allows the spinner 26 to be opened away from the supporting structure 27 in a generally pivotal manner but also permits the spinner 26 to be moved forwardly and way from the supporting structure 27 so as to prevent its outer edge 36 fouling against the support structure, as illustrated most clearly in FIG. 5.

The ends of the second hinge arms 35 which are pivotally connected to the spinner 26 are rigidly interconnected by a connecting bar 36 within which is formed a recess 37. The recess 37 defines the first part of an electrical connector 38 and is preferably formed as an electrical socket having conductor terminals which are electrically connected to a first length of cable 39. As will therefore be appreciated, the socket 37 of the electrical connector 38 is formed as an integral part of the hinge arrangement 29. The first length of cable 39 runs from the socket 37 to the heating elements 25 provided on the spinner 26, and in doing so may pass through an aperture 40 provided through the connecting bar 36 as illustrated in FIG. 6. The first cable 39 is preferably permanently connected to the heating elements 25.

The socket 37 described above is configured to receive a second part of the electrical connector 38, which is preferably provided in the form of a plug 41, as a releasably electrical connection. In the arrangement illustrated, the socket 37 is configured to receive the plug 41 along an insertion axis which is coincident with the third pivot axis 33 of the hinge arrangement 29.

The plug 41 is electrically connected, via a second length of cable 42 (and which is preferably a ribbon-type cable) to an electrical power supply (not illustrated) for the heating elements which is located separate and remotely from the nose cone 24.

The above-described arrangement, in which the first (socket) part 37 of the electrical connector 38 is formed as an integral part of the hinge arrangement 29 permits the spinner 26 of the nose cone assembly 24 to be moved from its operational closed position to its open position for maintenance purposes without requiring electrical disconnection of the heating elements 25 from their power supply. Because the socket 37 is fixed in position relative to the spinner 26 the length of the first cable 39 interconnecting the heating elements 25 and the socket 37 can be relatively short as it does not require additional length to permit movement of the spinner 26 away from the supporting structure 27 as the spinner 26 is opened for maintenance.

It is envisaged that normally the plug 41 will remain engaged with the socket 37 during movement of the spinner 26 from its closed position to its open position and during routine maintenance of the engine 10. The second cable 42 does require a certain amount of excess length to permit unrestricted opening of the hinge arrangement 29 without disconnection of the plug 41 from the socket 37, but this can easily be accommodated by carefully selecting the length of the cable 42 so that it conveniently folds away as the hinge arrangement 29 is actuated from the open configuration illustrated in FIG. 5 to the close configuration in FIG. 2, as illustrated.

When used in this specification and claims, the terms “comprises” and “comprising” and variations thereof mean that the specified features, steps or integers are included. The terms are not to be interpreted to exclude the presence of other features, steps or integers.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A hinge arrangement configured to hingedly interconnect a first component and a second component, the hinge arrangement incorporating a first part of an electrical connector which is formed as an integral feature of the hinge arrangement, said first part of the electrical connector being configured to releasably and electrically engage a second part of the electrical connector such that the second part of the electrical connector is separable from the hinge arrangement.

2. A hinge arrangement according to claim 1, wherein said first part of the electrical connector is provided in the form of a socket formed as an integral feature of the hinge arrangement, and said second part of the electrical connector is provided as a plug configured for releasable and electrical connection to the socket.

3. A hinge arrangement according to claim 2, wherein said socket is configured to receive said plug along an insertion axis which is substantially aligned with a pivot axis of the hinge arrangement.

4. A hinge arrangement according to claim 2, wherein said socket is configured to receive said plug along an insertion axis which is substantially coincident with a pivot axis of the hinge arrangement.

5. A hinge arrangement according to claim 1, wherein said first part of the electrical connector is electrically connected to electrical circuitry provided on said first component.

6. A hinge arrangement according to claim 5, wherein said first part of the electrical connector is permanently connected to said circuitry on said first component via a cable.

7. A hinge arrangement according to claim 5, wherein said circuitry on the first component includes at least one heating element.

8. A hinge arrangement according to claim 1, wherein said second part of the electrical connector is electrically connected to circuitry which is separate from said first component.

9. A hinge arrangement according to claim 8, wherein said second part of the electrical connector is permanently connected to said circuitry which is separate from the first component via a cable.

10. A hinge arrangement according to claim 9, wherein at least said cable connecting said second part of the electrical connector to said circuitry separate from the first component is a ribbon cable.

11. A hinge arrangement according to claim 8, wherein said electrical circuitry separate from the first component includes a power supply.

12. A hinge arrangement according to claim 1 having at least two pivot axes.

13. A hinge arrangement according to claim 12, wherein said pivot axes are substantially parallel.

14. A hinge arrangement according to claim 1, wherein said first and second components both form part of a nose cone assembly for a gas turbine engine.

15. A gas turbine engine incorporating a hinge arrangement according to claim 14.
